(19) United States
(12) Patent Application Publication
(10) Pub. No.: US 2011/0275732 A1
(43) Pub. Date: Nov. 10, 2011

(54) HIGHLY ELASTIC FLEXIBLE POLYURETHANE FOAMS

(75) Inventors: Bernd Bruchmann, Freinsheim (DE); Daniel Schoenfelder, Bruxelles (BE); Jens Ferbitz, Osnabrueck (DE); Andrea Eisenhardt, Vechta (DE)

(73) Assignee: BASF SE, Ludwigshafen (DE)

(21) Appl. No.: 13/144,223

(22) PCT Filed: Jan. 5, 2010
(86) PCT No.: PCT/EP2010/050023

§ 371 Date: Jul. 12, 2011

(30) Foreign Application Priority Data
Jan. 12, 2009 (EP) 09150398.7

(51) Int. Cl. C08G 18/00

(52) U.S. Cl. 521/156

(57) ABSTRACT

Flexible polyurethane foam which can be obtained by mixing
a) polyisocyanates with
b) at least one relatively high molecular weight compound having at least two reactive hydrogen atoms,
c) hyperbranched polyethers,
d) if appropriate a low molecular weight chain extender and/or crosslinker,
e) a catalyst,
f) blowing agents and
g) if appropriate other additives.

The present invention relates to highly elastic flexible polyurethane foams which can be obtained by mixing a) polyisocyanates with b) at least one relatively high molecular weight compound having at least two reactive hydrogen atoms, c) hyperbranched polyethers, d) if appropriate low molecular weight chain extenders and/or crosslinkers, e) catalysts, f) blowing agents and g) if appropriate other additives, a process for producing them and their use for producing furniture, mattresses, automobile seats and other upholstery in the automobile sector.

Flexible polyurethane foams are used predominantly for the production of furniture and mattresses and also for automobile seats and automobile carpets. Important properties for these applications are mechanical and mechanodynamic parameters such as hardness, elasticity, elongation, tensile strength, loss of modulus and storage modulus. With regard to the hardness and elasticity of flexible polyurethane foams, an increase in the elasticity generally leads to a decrease in the hardness.

For most applications, for example upholstery for seats or mattresses, there are firmly prescribed requirements in terms of the hardness. However, an important comfort feature of flexible polyurethane foams is a very high elasticity.

A further important parameter for flexible polyurethane foams is the density. Efforts are made to reduce the density for cost and weight reasons in order to use very little material. However, a reduction in the density at a constant hardness leads to a reduction in the elasticity.

A further comfort feature for polyurethane foams, in particular when they are used as automobile seats, is vibration damping.

It is known from WO 03/062297 that dendritic polyethers can be used for producing polyurethane foams and lead to improved foam stability at a lower density and higher compressive strength.

It is known from WO 02/10247 that a dendritic polyester can be used as additive to increase the hardness and the pressure stability of isocyanate-based polymer foams at a constant density. The dendritic polymer here can be any type of dendritic polymer which has a content of active hydrogen atoms of greater than 3.8 mmol/g and an OH functionality of greater than 8 and is miscible to an extent of at least 15% by weight, based on the weight of the dendritic polymer, with a polyetherol having an OH number of less than 40.

A disadvantage of the known dendritic and hyperbranched additives from the prior art is that these additives lead to predominantly closed-celled polyurethane foams. However, closed-celled polyurethane foams have a reduced elasticity compared to open-celled foams. Furthermore, the processing of closed-celled flexible polyurethane foams is difficult since the cell gases comprised in the cells contract due to cooling of the foam after the reaction, which leads to undesirable shrinkage of the polyurethane foams. Although it is possible to keep the cells of the polyurethane foam formed open by means of further additives such as surfactants, these additives are expensive and lead to impaired mechanical properties of the foam. Furthermore, these polyurethane foams can only be produced using specific isocyanates and additives since otherwise incompatibility occurs and leads to the occurrence of foam defects or the foam not being able to be produced.

WO 2008/071622 describes a flexible polyurethane foam which can be obtained by mixing a) polyisocyanate with b) at least one relatively high molecular weight compound having at least two reactive hydrogen atoms, c) a hyperbranched polyester c1) of the AₓB_{y} type, where x is at least 1.1 and y is at least 2.1, and/or a hyperbranched polycarbonate c2), d) if appropriate low molecular weight chain extenders and/or crosslinkers, e) a catalyst, f) blowing agents and g) if appropriate other additives. The flexible polyurethane foams described there have a good property profile but their hot/humid storage stability is capable of improvement.

It was an object of the present invention to provide polyurethane foams which have a high hardness and nevertheless a high elasticity.

A further object of the present invention was to provide polyurethane foams which display a broad process range and can be used as slabstock flexible foams or molded forms.

Finally, it was an object of the invention to provide polyurethane foams having good comfort properties in the form of damping properties, for example a low transmission (vibration damping) at the resonant frequency. In addition, the hot/humid storage stability of the polyurethane foams should be improved.

The object is achieved by a process for producing elastic flexible polyurethane foams, in which (a) polyisocyanates are mixed with (b) at least one relatively high molecular weight compound having at least two reactive hydrogen atoms, (c) hyperbranched polyetherols, (d) if appropriate low molecular weight chain extenders and/or crosslinkers, (e) catalysts, (f) blowing agents and (g) if appropriate other additives to give a reaction mixture and cured to give the flexible polyurethane foam, and also by the elastic flexible polyurethane foams themselves.

For the purposes of the invention, flexible polyurethane foams are polyisocyanate polyaddition products which are foams in accordance with DIN 7726 and have a compressive stress at 10% deformation or compressive strength in accordance with DIN 53 421/DIN EN ISO 604 of 15 kPa or below, preferably from 1 to 14 kPa and in particular from 4 to 14 kPa. For the purposes of the invention, flexible polyurethane foams preferably have a proportion of open cells in accordance with DIN ISO 4590 of preferably greater than 85%, particularly preferably greater than 90%.

The polyisocyanate component (a) used for producing the flexible polyurethane foams of the invention comprises all polyisocyanates known for producing polyurethanes. These comprise the aliphatic, cycloaliphatic and aromatic, two-ring or multiring isocyanates known from the prior art and any mixtures thereof. Examples are diphenylmethane 2,2″-, 2,4″- and 4,4″-diisocyanate, mixtures of monomeric diphenylmethane diisocyanates and higher homologues of diphenylmethane diisocyanate having more than two rings (polymeric MDI), isophorone diisocyanate (IPDI) or oligomers thereof, tolylene 2,4- or 2,6-diisocyanate (TDI) or mixtures thereof, tetramethylene diisocyanate or oligomers thereof, hexamethylene diisocyanate (HDI) or oligomers thereof, naphthylene diisocyanate (NDI) or mixtures thereof.

Preference is given to using diphenylmethane 2,2″-, 2,4″- and 4,4″-diisocyanate, mixtures of monomeric diphenylmethane diisocyanates and higher homologues of diphenylmethane diisocyanate having more than two rings (polymeric MDI), tolylene 2,4- or 2,6-diiscocyanate (TDI) or mixtures thereof, isophorone diisocyanate (IPDI) of oligomers thereof, hexamethylene diisocyanate (HDI) or oligomers thereof or mixtures of the isocyanates mentioned. The isocyanates which are preferably used can also comprise uretdione, allophanate, uretonimine, urea, biuret, isocyanurate or iminooxadiazinetrione groups. Further possible isocyanates are indicated, for example, in “Kunststoffhandbuch, Volume 7, Polyurethane”, Carl Hanser Verlag, 3rd edition 1993, chapters 3.2 and 3.3.2.

The polyisocyanate (a) is alternatively used in the form of polyisocyanate prepolymers. These polyisocyanate prepolymers can be obtained by reacting polyisocyanates described above (a1) with polyols (a2), for example at temperatures of from 30 to 100° C., preferably at about 80° C., to give the prepolymer. The prepolymers used according to the invention are preferably prepared using polyols based on polyesters, for example derived from adipic acid, or polyethers, for example derived from ethylene oxide and/or propylene oxide.

Polyols (a2) are known to those skilled in the art and are described, for example, in “Kunststoffhandbuch, 7, Polyurethane”, Carl Hanser Verlag, 3rd edition 1993, chapter 3.1. Relatively high molecular weight compounds having at least two reactive hydrogen atoms as described under (b) are preferably used as polyols (a2).

In one embodiment, a hyperbranched polyether having hydrogen atoms which are reacted toward isocyanates can be used as constituent (a2) for preparing the prepolymer.

If appropriate, chain extenders (a3) can be introduced into the reaction to form the polyisocyanate prepolymer. Suitable chain extenders (a3) for the prepolymer are dihydric or trihydric alcohols, for example dipropylene glycol and/or tripropylene glycol, or the adducts of dipropylene glycol and/or tripropylene glycol with alkylene oxides, preferably propylene oxide.

As relatively high molecular weight compound having at least two reactive hydrogen atoms (b), use is made of the compounds which are known and customary for the production of flexible polyurethane foams.

Preferred compounds having at least two active hydrogen atoms (b) are polyester alcohols and/or polyether alcohols having a functionality of from 2 to 8, in particular from 2 to 6, preferably from 2 to 4, and an average equivalent molecular weight in the range from 400 to 3000 g/mol, preferably from 1000 to 2500 g/mol.

The polyether alcohols can be prepared by known methods, usually by catalytic addition of alkylene oxides, in particular ethylene oxide and/or propylene oxide, onto H-functional starter substances, or by condensation of tetrahydrofuran. As H-functional starter substances, use is made of, in particular, polyfunctional alcohols and/or amines. Particular preference is given to using water, dihydric alcohols, for example ethylene glycol, propylene glycol or butanediols, trihydric alcohols, for example glycerol or trimethylolpropane, and also higher-hydric alcohols such as pentaerythritol, sugar alcohols, for example sucrose, glucose or sorbitol. Amines which are preferably used are aliphatic amines having up to 10 carbon atoms, for example ethylenediamine, diethylenetriamine, propylenediamine, and also amino alcohols such as ethanolamine or diethanolamine. As alkylene oxides, preference is given to using ethylene oxide and/or propylene oxide, with an ethylene oxide block frequently being added on at the end of the chain in the case of polyether alcohols used for producing flexible polyurethane foams. Catalysts used in the addition reaction of the alkylene oxides are, in particular, basic compounds, with potassium hydroxide having the greatest industrial importance here. When the content of unsaturated constituents in the polyether alcohols is to be low, it is also possible to use dimetal or multimetal cyanide compounds, known as DMC catalysts, as catalysts. It is also possible to use the polyether alcohol used for the preparation of the prepolymer in the component b).

To produce flexible foams and integral foams, particular preference is given to using bifunctional and/or trifunctional polyether alcohols.

Furthermore, it is possible to use polyester polyols, for example ones which can be prepared from organic dicarboxylic acids having from 2 to 12 carbon atoms, preferably aliphatic dicarboxylic acids having from 8 to 12 carbon atoms, and polyhydric alcohols, preferably diols, having from 2 to 12 carbon atoms, preferably from 2 to 6 carbon atoms, as compound having at least two active hydrogen atoms. Possible dicarboxylic acids are, for example: succinic acid, glutaric acid, adipic acid, suberic acid, azelaic acid, sebacic acid, decanedicarboxylic acid, maleic acid, fumaric acid, phthalic acid, isophthalic acid, terephthalic acid and the isomeric naphthalenedicarboxylic acids. Preference is given to using adipic acid. The dicarboxylic acids can be used either individually or in admixture with one another. Instead of the free dicarboxylic acids, it is also possible to use the corresponding dicarboxylic acid derivatives, e.g. dicarboxylic esters of alcohols having from 1 to 4 carbon atoms or dicarboxylic anhydrides.

Examples of dihydric and polyhyric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol and trimethylolpropane. Preference is given to using ethanediol, diethylene glycol, 1,4-butanediol, 1,5-pentanediol, 1,6-hexanediol or mixtures of at least two or the diols mentioned, in particular mixtures of 1,4-butanediol, 1,5-pentanediol and 1,6-hexanediol. Use can also be made of polyester polyols derived from lactones, e.g. ε-caprolactone, or hydroxycarboxylic acids, e.g. ω-hydroxycaproic acid and hydroxybenzoic acids. Preference is given to using dipropylene glycol.

The hydroxyl number of the polyester alcohols is preferably in the range from 40 to 100 mg KOH/g.

Further suitable polyols are polymer-modified polyols, preferably polymer-modified polyesterols or polyetherols, particularly preferably graft polyetherols or graft polyesterols, in particular graft polyetherols. A polymer-modified polyol is a polymer polyol which usually has a content of preferably thermoplastic polymers of from 5 to 60% by weight, preferably from 10 to 55% by weight, particularly preferably from 30 to 55% by weight and in particular from 40 to 50% by weight.

Polymer polyols are described, for example, in EP-A-250 351, DE 111 394, U.S. Pat. No. 3,304,273, U.S. Pat. No. 3,383,351, U.S. Pat. No. 3,523,093, DE 1 152 536 and DE 1 152 537 and are usually prepared by free-radical polymerization of suitable olefinic monomers, for example styrene, acrylonitrile, (meth)acrylates, (meth)acrylic acid and/or acrylamide, in a polyol, preferably polyesterol or polyetherol, serving as graft base. The side chains are generally formed by transfer of the free radicals of growing polymer chains to polyols. The polymer polyol comprises, in addition to the graft copolymers, predominantly the homopolymers of the olefins, dispersed in unchanged polyol.

In a preferred embodiment, acrylonitrile, styrene, in particular exclusively styrene, is/are used as monomer(s). The monomers are, if appropriate, polymerized in the presence of further monomers, of a macromer, of a moderator and using a free-radical initiator, usually azo or peroxide compounds, in a polyesterol or polyetherol as continuous phase.

If polymer polyol is comprised in the relatively high molecular weight compound (b), it is preferably present together with further polyols, for example polyetherols, polyesterols or mixtures of polyetherols and polyesterols. The proportion of polymer polyol is particularly preferably greater than 5% by weight, based on the total weight of the component (b). The polymer polyols can, for example, be comprised in an amount of from 7 to 90% by weight or from 11 to 80% by weight, based on the total weight of the component (b). The polymer polyol is particularly preferably a polymer polyesterol or polymer polyetherol.

For the purposes of the present invention, hyperbranched polyether polyols (c) are uncrosslinked polymer molecules which have hydroxyl and ether groups and are both structurally and molecularly nonuniform. They can, on the one hand, be built up from a central molecule in a manner analogous to dendrimers but with a nonuniform chain length of the branches. On the other hand, they can also have linear regions with functional side groups. For the definition of dendritic and hyperbranched polymers, see also P. J. Flory, J. Am. Chem. Soc. 1952, 74, 2718 and H. Frey et al., Chem. Eur. J. 2000, 6, No. 14, 2499.

The hyperbranched polyetherols (c) have, in addition to the ether groups which form the polymer framework, at least three, preferably at least six, particularly preferably at least ten, OH groups located at the end of or along the chain. The number of terminal or lateral functional groups is in principle not subject to any upper limit, although products having a very large number of functional groups can have undesirable properties, for example a high viscosity or poor solubility. The hyperbranched polyetherols (c) usually have not more than 500 terminal or lateral functional groups, preferably not more than 100 terminal or lateral functional OH groups.

The hyperbranched polyetherols (c) are obtained by condensation of bifunctional, trifunctional or higher-functional alcohols.

The hyperbranched polyetherol used according to the invention is preferably the condensation product of on average at least 3, particularly preferably at least 4, more preferably at least 5 and in particular at least 6, bifunctional, trifunctional or higher-functional alcohols. Preference is also given to the hyperbranched polyetherol being the condensation product of on average at least 3, particularly preferably at least 4, especially at least 5 and in particular at least 6, trifunctional or higher-functional alcohols.

For the purposes of the present invention, “hyperbranched” means that the degree of branching (DB), i.e. the average number of dendritic linkages plus the average number of end groups per molecule divided by the sum of the average number of dendritic, linear and terminal linkages, multiplied by 100, is from 10 to 99.9%, preferably from 20 to 99%, particularly preferably from 20 to 95%. For the purposes of the present invention, a “dendrimer” has a degree of branching of from 99.9 to 100%. For the definition of the “degree of branching”, see H. Frey et al., Acta Polym. 1997, 48, 30.

As trifunctional and higher-functional alcohols, it is possible to use, for example, triols such as trimethylolmethane, trimethylolethane, trimethylolpropane (TMP), 1,2,4-butanetriol, trishydroxymethyl isocyanurate and a trishydroxyethyl isocyanurate (THEIC). It is likewise possible to use tetrols such as bistrimethylolpropane (diTMP) or pentaerythritol. Furthermore, it is possible to use higher-functional polyols such as bis-pentaerythritol (di-penta) or inositols. Furthermore, alkoxylation products of the abovementioned alcohols and of glycerol, preferably alkoxylation products having 1-40 alkylene oxide units per molecule, can also be used.

Particular preference is given to using aliphatic alcohols and in particular those having primary hydroxyl groups, e.g. trimethylolmethane, trimethylolethane, trimethylolpropane, diTMP, pentaerythritol, di-penta and alkoxylates thereof having 1-30 ethylene oxide units per molecule and also glycerol ethoxylates having 1-30 ethylene oxide units per molecule, as trifunctional and higher-functional alcohols. Very particular preference is given to using trimethylolpropane, pentaerythritol and ethoxylates thereof having an average of 1-20 ethylene oxide units per molecule and also glycerol ethoxylates having 1-20 ethylene oxide units per molecule. It is likewise possible to use the alcohols mentioned in admixture.

Compounds bearing OH groups on two directly adjacent carbon atoms are less suitable as trifunctional and higher-functional alcohols. These compounds tend to undergo elimination reactions which can proceed preferentially over the etherification reaction under conditions according to the invention. The unsaturated compounds formed produce by-products under etherification conditions according to the invention and these by-products lead to the reaction product being unusable in industrially relevant formulations. In particular, such secondary reactions can occur when using glycerol.

The trifunctional and higher-functional alcohols can also be used in admixture with bifunctional alcohols. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, hexanediol, dodecanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, bifunctional polyether polyols based on ethylene oxide, propylene oxide, butylene oxide or mixtures thereof having from 1 to 50, preferably from 2 to 10, alkylene oxide units or polytetrahydrofuran (PTFF) having a number-average molecular weight of from 160 to 2000 g/mol. The bifunctional alcohols can of course also be used in mixtures. Preferred bifunctional alcohols are ethylene glycol, diethylene glycol, triethylene glycol, 1,2- and 1,3-propanediol, dipropylene glycol, tripropylene glycol, neopentyl glycol, 1,4-butanediol, 1,5-pentanediol, hexanediol, dodecanediol, bis(4-hydroxycyclohexyl)methane and bifunctional polyether polyols based on ethylene oxide and/or propylene oxide, or mixtures thereof. Particularly preferred bifunctional alcohols are ethylene glycol, diethylene glycol, triethylene glycol, 1,2-propanediol, dipropylene glycol, tripropylene glycol, 1,4-butanediol, hexanediol, bis(4-hydroxycyclohexyl)methane and bifunctional polyether polyols based on ethylene oxide and/or propylene oxide, or mixtures thereof.

The diols are employed for effecting fine adjustment of the properties of the polyether polyol. If bifunctional alcohols are used, the ratio of bifunctional alcohols to the trifunctional and higher-functional alcohols is set by a person skilled in the art according to the desired properties of the polyether. In general, the amount of the bifunctional alcohol or alcohols is from 0 to 99 mol %, preferably from 0 to 80 mol %, particularly preferably from 0 to 75 mol % and very particularly preferably from 0 to 50 mol %, based on the total amount of all alcohols. Here, block copolyethers, for example diol-terminated polyethers, can also be obtained by alternate addition of trifunctional and higher-functional alcohols and diols during the course of the reaction.

The bifunctional alcohols can also be precondensed to form OH-terminated oligomers and the trifunctional or higher-functional alcohol can subsequently be added. In this way, hyperbranched polymers having linear block structures can likewise be obtained.

Furthermore, monools can also be added during or after the reaction of the trifunctional and higher-functional alcohols to regulate the OH functionality. Such monools can be, for example, linear or branched aliphatic or aromatic monools. These preferably have more than 3, particularly preferably more than 6, carbon atoms. Further suitable monools are monofunctional polyetherols. Preference is given to adding a maximum of 50 mol % of monool, based on the total amount of trifunctional and higher-functional alcohol.

To accelerate the reaction, acid catalysts or catalyst mixtures are added. Suitable catalysts are, for example, acids having a pKₐ of less than 2.2, with particular preference being given to strong acids.

Examples of acids having a pKₐ of less than 2.2 are phosphoric acid (H₃PO₄), phosphorous acid (H₃PO₃), pyrophosphoric acid (H₄P₂O₇), polyphosphoric acid, hydrogensulfate (HSO₄⁻), sulfuric acid (H₂SO₄), perchloric acid, hydrochloric acid, hydrobromic acid, chlorosulfonic acid, methanesulfonic acid, trichloromethansulfonic acid, trifluoromethanesulfonic acid, benzenesulfonic acid and p-toluenesulfonic acid.

Further examples of acid catalysts are acidic ion exchangers or ion exchanger resins. Ion exchangers is the collective term for solids or liquids which are capable of taking up positively or negatively charged ions from an electrolyte solution with release of equivalent amounts of other ions. Preference is given to using solid grains and particles whose matrix has been obtained by condensation (phenol-formaldehyde) or by polymerization (copolymers of styrene and divinylbenzene and of methacrylates and divinylbenzene).

The acidic ion exchangers used bear, for example, sulfonic acid groups, carboxylic acid groups or phosphonic acid groups. It is also possible to use ion exchangers which have a hydrophilic cellulose framework or comprise crosslinked dextran or agarose and bear acidic functional groups, for example carboxymethyl or sulfoethyl groups. It is also possible to use inorganic ion exchangers such as zeolites, montmorillonites, palygorskites, bentonites and other aluminum silicates, zirconium phosphate, titanium tungstate and nickel hexacyanoferrate(II). On the subject of ion exchangers, see also RÖMPP, Chemisches Lexikon, Online Version 3.0, or “Ion Exchangers” by F. De Dardel and T. V. Arden in Ullmann's Encyclopedia of Industrial Chemistry, Electronic Release 2007. Acidic ion exchangers are, for example, obtainable in solid or dissolved form under the product names Amberlite™, Ambersept™ or Amberjet™ from Rohm and Haas.

Particularly preferred catalysts are phosphoric acid, polyphosphoric acid, chlorosulfonic acid, methanesulfonic acid, trichloromethanesulfonic acid, trifluoromethanesulfonic acid, benzenesulfonic acid, p-toluenesulfonic acid and acidic ion exchangers. Very particular preference is given to methanesulfonic acid, trifluoromethanesulfonic acid, p-toluenesulfonic acid and acidic ion exchangers.

The acid as catalyst is generally added in an amount of from 50 ppm to 10% by weight, preferably from 100 ppm to 5% by weight, particularly preferably from 1000 ppm to 3% by weight, based on the amount of alcohol or alcohol mixture used.

If an acidic ion exchanger is used as catalyst, it is usual to add an amount of from 1000 ppm to 30% by weight, preferably from 1 to 25% by weight, particularly preferably from 1 to 20% by weight, based on the amount of alcohol or alcohol mixture used. Of course, the catalysts can also be used in admixture.

Furthermore, it is possible to control the polycondensation reaction both by addition of the suitable catalyst and by selection of a suitable temperature. In addition, the average molecular weight of the polymer and its structure can be adjusted via the composition of the starting components and via the residence time.

The reaction is usually carried out at a temperature of from 0 to 300° C., preferably from 0 to 250° C., particularly preferably from 60 to 250° C. and very particularly preferably from 80 to 250° C., in bulk or in solution. Here, it is possible in general to use all solvents which are inert toward the respective starting materials. If solvent is used, preference is given to using organic solvents such as decane, dodecane, benzene, toluene, chlorobenzene, xylene, dimethylformamide, dimethylacetamide or solvent naphtha.

In a particularly preferred embodiment, the condensation reaction is carried out in bulk, i.e. without addition of solvent. The water liberated in the reaction can be removed from the reaction equilibrium, for example by distillation, if appropriate under reduced pressure, in order to accelerate the reaction.

The preparation of the high-functionality polyether polyols according to the invention is usually carried out in the pressure range from 0.1 mbar to 20 bar, preferably from 1 mbar to 5 bar, in reactors which are operated batchwise, semicontinuously or continuously.

The reaction is preferably carried out in a “one-pot” mode in which all of the monomer is initially charged and the reaction is carried out in a backmixed reactor. However, carrying out the reaction in a multistage reactor system, for example a cascade of stirred vessels or a tube reactor, is also conceivable. In an alternative embodiment of the present invention, the reaction can be carried out in a kneader, extruder, intensive mixer or paddle dryer.

The reaction can, if appropriate, also be carried out with the aid of ultrasound or microwave radiation.

There are various possible ways of stopping the intermolecular polycondensation reaction. For example, the temperature can be reduced to a range in which the reaction ceases and the condensation product is storage-stable.

Furthermore, it is possible to deactivate the catalyst, for example by addition of a basic component such as a Lewis base or an organic or inorganic base.

In a further preferred embodiment, the polyetherols according to the invention can comprise further functional groups in addition to the OH groups obtained by means of the reaction. These comprise mercapto groups, primary, secondary or tertiary amino groups, ester groups, carboxylic acid groups or derivatives thereof, sulfonic acid groups or derivatives thereof, phosphonic acid groups or derivatives thereof, silane groups, siloxane groups, aryl radicals or short- or long-chain alkyl radicals. Modifying reagents are used for this purpose. These are compounds which have such a further functional group and a group which is reactive toward alcohol. Such groups which are reactive toward alcohol can be, for example, isocyanate groups, acid groups, acid derivatives, epoxide groups or alcohol groups. Here, the modifying reagents can be added before or during the reaction of the trifunctional or higher-functional alcohols to form the high-functionality polyether.

If the trifunctional or higher-functional alcohol or alcohol mixture is reacted in one step in the presence of modifying reagents, a polyether polymer having randomly distributed functions other than hydroxyl groups is obtained. Such functionalization can be achieved, for example, by addition of compounds bearing mercapto groups, primary, secondary or tertiary amino groups, ester groups, carboxylic acid groups or derivatives thereof, aryl radicals or short- or long-chain alkyl radicals.

Subsequent functionalization can be obtained by reacting the high-functionality, highly branched or hyperbranched polyether polyol obtained with a suitable functionalization reagent which can react with the OH groups of the polyether in an additional process step.

The high-functionality polyethers according to the invention can be modified by, for example, addition of modifying reagents comprising acid, acid anhydride, acid halide or isocyanate groups.

In a preferred embodiment, the hyperbranched polyetherols according to the invention can also be converted by reaction with alkylene oxides, for example ethylene oxide, propylene oxide, butylene oxide or mixtures thereof, as modifying reagents into high-functionality polyether polyols comprising linear polyether chains having an adjustable polarity. Here, the alkoxylation reaction is carried out by customary methods known to those skilled in the art as are also used for preparing polyetherols (b).

The specific choice of the reaction conditions such as pressure and temperature and the concentration of the alcohols and, if appropriate, the modifying reagents depends on the reactivity of the alcohols and of the modifying reagents. In principle, a lower temperature, a higher reactivity of the modifying reagents and a higher concentration of the modifying reagents tends to give low molecular weight modified alcohols, while a higher temperature, a lower concentration of modifying reagents and a lower reactivity of the modifying reagents tends to give condensation products which have a plurality of bifunctional, trifunctional and higher-functional alcohols per molecule. The reaction conditions in the process of the invention are preferably selected so that the polyether polyols obtained comprise condensation products made up of on average at least 3, particularly preferably at least 4, more preferably at least 5 and in particular at least 6, bifunctional, trifunctional or higher-functional alcohols. The reaction conditions are also preferably selected so that the high-functionality polyether polyols obtained are condensation products made up of on average at least 3, particularly preferably at least 4, more preferably at least 5 and in particular at least 6 trifunctional or higher-functional alcohols. The number of bifunctional, trifunctional or higher-functional alcohols in the condensation product can be determined, for example, from the number-average molecular weight Mₙ determined by GPC.

The number-average molecular weight of the polyetherols used according to the invention is generally from 400 to 20 000 g/mol, preferably from 500 to 10 000 g/mol, more preferably from 600 to 5000 g/mol and particularly preferably from 800 to 2000 g/mol.

The abovementioned setting of the reaction conditions and, if appropriate, the selection of a suitable solvent enables the products according to the invention to be processed further without further purification after they have been prepared.

In a further preferred embodiment, the reaction product is purified by stripping, i.e. by removal of low molecular weight, volatile compounds. For this purpose, the catalyst can be deactivated after the desired degree of conversion has been reacted. The low molecular weight volatile constituents, for example solvents, starting monomers, volatile dissociation products, volatile oligomeric or cyclic compounds or water, are subsequently removed by distillation, if appropriate with introduction of a gas, preferably nitrogen, carbon dioxide or air, if appropriate under reduced pressure. In a preferred embodiment, the product is freed of volatile constituents in a thin film evaporator.

Owing to the nature of the starting monomers, it is possible for condensation products having different structures and having branches and cyclic units but no crosslinks to result from the reaction. The number of reactive groups is determined by the nature of the monomers used and the degree of polycondensation which should be selected so that the gel point is not reached.

The high-functionality-branched polyetherols used according to the invention as component (c) dissolve readily in various solvents, for example in water, alcohols such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate or propylene carbonate.

In the production of the flexible polyurethane foam of the invention, the polyisocyanates (a), the relatively high molecular weight compounds having at least two reactive hydrogen atoms (b), hyperbranched polyethers (c) and, if appropriate, chain extenders and/or crosslinkers (d) are generally reacted in such amounts that the equivalence ratio of NCO groups of the polyisocyanates (a) to the sum of the reactive hydrogen atoms of the components (b), (c) and, if appropriate, (d) and (f) is 0.7-1.25:1, preferably 0.80-1.15:1. A ratio of 1:1 corresponds to an isocyanate index of 100. The proportion of component (c) is preferably in the range from 0.01 to 90% by weight, particularly preferably from 0.5 to 50% by weight and very particularly preferably from 0.7 to 30% by weight, based on the total weight of the components (a) to (g).

As chain extenders and/or crosslinkers (d), use is made of substances having a molecular weight of preferably less than 500 g/mol, particularly preferably from 60 to 400 g/mol, with chain extenders having 2 hydrogen atoms which are reactive toward isocyanates and crosslinkers having 3 hydrogen atoms which are reactive toward isocyanate. These can be used individually or in the form of mixtures. Preference is given to using diols and/or triols having molecular weights of less than 400, particularly preferably from 60 to 300 and in particular from 60 to 150. Possible chain extenders/crosslinkers are, for example, aliphatic, cycloaliphatic and/or araliphatic diols having from 2 to 14, preferably from 2 to 10, carbon atoms, e.g. ethylene glycol, 1,3-propanediol, 1,10-decanediol, o-, m-, p-dihydroxycyclohexane, diethylene glycol, dipropylene glycol and preferably 1,4-butanediol, 1,6-hexanediol and bis(2-hydroxyethyl)hydroquinone, triols such as 1,2,4-, 1,3,5-trihydroxycyclohexane, glycerol and trimethylolpropane and low molecular weight hydroxyl-comprising polyalkylene oxides based on ethylene oxide and/or 1,2-propylene oxide and the abovementioned diols and/or triols as starter molecules. Particular preference is given to using monoethylene glycol, 1,4-butanediol and/or glycerol as chain extenders (d).

When used, chain extenders, crosslinkers or mixtures thereof are used, they are advantageously used in amounts from 1 to 60% by weight, preferably from 1.5 to 50% by weight and in particular from 2 to 40% by weight, based on the weight of the components (b), (c) and (d).

As catalysts (e) for producing the polyurethane foams, preference is given to using compounds which strongly accelerate the reaction of the hydroxyl-comprising compounds of components (b), (c) and, if appropriate, (d) with the polyisocyanates (a). Examples which may be mentioned are amidines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′,N′-tetramethyl-ethylenediamine, N,N,N′,N′-tetramethyl-butanediamine, N,N,N′,N′-tetramethylhexane-diamine, pentamethyldiethylenetriamine, bis(dimethylaminoethyl)ether, bis(dimethylaminopropyl)urea, dimethylpiperazine, 1,2-dimethylimidazole, 1-azabicyclo[3.3.0]octane and preferably 1,4-diazabicyclo[2.2.2]-octane and alkanolamine compounds such as triethanolamine, triisopropanolamine, N-methyldiethanolamine and N-ethyldiethanolamine and dimethylethanolamine. It is likewise possible to use organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate, or mixtures thereof. The organic metal compounds can be used either alone or preferably in combination with strongly basic amines. If component (b) is an ester, preference is given to using exclusively amine catalysts.

Preference is given to using from 0.001 to 5% by weight, in particular from 0.05 to 2% by weight, of catalyst or catalyst combination, based on the weight of the components (b), (c) and (d).

Furthermore, blowing agents (f) are present in the production of polyurethane foams. As blowing agents (f), it is possible to use chemically acting blowing agents and/or physically acting compounds. For the purposes of the present invention, chemical blowing agents are compounds which form gaseous products by reaction with isocyanate, for example water or formic acid. Physical blowing agents are compounds which are dissolved or emulsified in the starting materials for polyurethane production and vaporize under the conditions of polyurethane formation. These are, for example, hydrocarbons, halogenated hydrocarbons and other compounds, for example perfluorinated alkanes such as perfluorohexane, chlorofluorocarbons, and ethers, esters, ketones and/or acetals, for example (cyclo)aliphatic hydrocarbons having from 4 to 8 carbon atoms, fluorinated hydrocarbons such as Solkane® 365 mfc or gases such as carbon dioxide. In a preferred embodiment, a mixture of these blowing agents and water is used as blowing agent. If no water is used as blowing agent, preference is given to using exclusively physical blowing agents.

The content of physical blowing agents (f) is, in a preferred embodiment, in the range from 1 to 20% by weight, in particular from 5 to 20% by weight, and the amount of water is preferably in the range from 0.5 to 10% by weight, in particular from 1 to 5% by weight. Preference is given to using carbon dioxide as blowing agent (f), and this is introduced either on-line, i.e. directly into the mixing head, or via the stock tank in batch operation.

As auxiliaries and/or additives (g), use is made of, for example, surface-active substances, foam stabilizers, cell regulators, external and internal mold release agents, fillers, pigments, hydrolysis inhibitors and fungistatic and bacteriostatic substances.

In the industrial production of polyurethane foams, it is usual to combine the compounds having at least two active hydrogen atoms (b) and one or more of the starting materials (c) to (g), if not already used for preparing polyisocyanate prepolymers, to form a polyol component before the reaction with the polyisocyanate (a).

Further information on the starting materials used may be found, for example, in the Kunststoffhandbuch, volume 7, Polyurethane, edited by Gunter Oertel, Carl-Hanser-Verlag, Munich, 3rd edition 1993.

To produce the polyurethanes of the invention, the organic polyisocyanates are reacted with the compounds having at least two active hydrogen atoms in the presence of the abovementioned blowing agents, catalysts and auxiliaries and/or additives (polyol component).

In the production of the flexible polyurethane foams according to the invention, the polyisocyanates (a), the relatively high molecular weight compounds having at least two reactive hydrogen atoms (b), hyperbranched polyether (c) and, if appropriate, the chain extenders and/or crosslinkers (d) are generally reacted in such amounts that the equivalence ratio of NCO groups of the polyisocyanates (a) to the sum of the reactive hydrogen atoms of the components (b), (c) and, if appropriate, (d) and (f) is 0.7-1.25:1, preferably 0.80-1.15:1. A ratio of 1:1 corresponds to an isocyanate index of 100.

The polyurethane foams are preferably produced by the one-shot process, for example with the aid of the high-pressure or low-pressure technique. The foams can be produced in open or closed metallic molds or by continuous application of the reaction mixture to conveyor belts in order to produce slabstock foams.

It is particularly advantageous to employ the two-component process in which, as described above, a polyol component is produced and foamed with polyisocyanate a). The components are preferably mixed at a temperature in the range from 15 to 120° C., preferably from 20 to 80° C., and introduced into the mold or applied to the conveyor belt. The temperature in the mold is usually in the range from 15 to 120° C., preferably from 30 to 80° C.

Flexible polyurethane foams according to the invention are preferably used as upholstery for furniture and mattresses, orthopedic products such as cushions, for upholstery in the automobile sector, e.g. armrests, headrests and in particular automobile seats, and have improved elasticity values at the same hardnesses. Furthermore, when hyperbranched polyethers are used, flexible polyurethane foams according to the invention have improved hot/humid storage stability compared to foams produced using hyperbranched polyesters.

A further advantage of the polyurethanes of the invention is a pronounced damping behavior. Here, the damping behavior is determined by exciting the foam specimen having a thickness of 10 cm and a weight of 50 kg in a frequency range of 2-20 Hz at an excitation amplitude of +/−1 mm under standard conditions of temperature and humidity. The ratio of the measured deflection of the upper surface of the foam as a result of the excitation, in each case in mm, gives the transmission. The frequency at which the maximum deflection is measured is referred to as the resonant frequency. Since the human body is particularly sensitive to vibrations in a frequency range of 2-20 Hz, the transmission in this range, particularly in the region of the resonant frequency, should be very small.

The invention is illustrated below with the aid of examples of the use of hyperbranched polyols in flexible foams.

In the examples, the foam density was determined in accordance with DIN EN ISO 845.

Furthermore, the compressive strength was determined in accordance with DIN EN ISO 3386 and the rebound resilience was determined in accordance with DIN 53573.

### EXAMPLES

### Starting Materials:

Polyol 1: Polyoxypropylene-polyoxyethylene polyol, OH number: 28, functionality: 2.7
Polyol 2: Graft polyol based on styrene-acrylonitrile and having a solids content of 45% in a polyoxypropylene-polyoxyethylene polyol, OH number: 20, functionality: 2.7
Polyol 3: Polyoxypropylene-polyoxyethylene polyol, OH number: 42, functionality: 2.6
Polyol 4: Polyether polyol, OH number: 250, functionality: 3

### Catalysis: Standard Amine Catalysis

HB Polyol 1: Polyol derived from pentaerythritol/triethylene glycol, OH number: 536, prepared by the method below:

The polymerization is carried out in a 4 l glass flask equipped with a stirrer, reflux condenser and a 20 cm long packed column with distillation attachment and vacuum connection. The mixture of 1225.4 g of pentaerythritol (9.0 mol), 1351.2 g of triethylene glycol (9.0 mol) and 2.0 g of p-toluenesulfonic acid monohydrate (0.08% by weight) is slowly heated to 180° C. by means of an oil bath. After the reaction temperature has been reached, the flask is evacuated and the reaction mixture is stirred at a pressure of 200 mbar for 15 hours. The water of reaction formed in the reaction is removed by distillation. After a reaction time of about 17 hours, a total of 596 g of aqueous phase have been distilled off.

The product had the following properties:

M_{w}, Mₙ (GPC; DMF) 14,100, 900 [g/mol]
OHN: 536 mg of KOH/g of polymer
Isocyanate 1: Diphenylmethane diisocyanate, NCO content: 32.8
Isocyanate 2: Tolylene diisocyanate/diphenylmethane diisocyanate 80/20, NCO content: 44.8
Catalyst: Low-emission amine catalysis

### Examples 1-3 and Comparative Example 1

Molded MT foams (molded foams based on MDI/TD) were produced and their mechanical properties were determined.

The composition of the formulations and the results of the mechanical tests are shown in the following table.

| | Formulation | | | |
|---|---|---|---|---|
| | Comparative | | | |
| | example | Example | | |
| | 1 | 1 | 2 | 3 |
| Polyol 1 [pbm*] | 74 | 74 | 74.0 | 74.0 |
| Polyol 2 [pbm] | 25 | 25 | 25 | 25 |
| Polyol 3 [pbm] | 1.0 | 1.0 | 1.0 | 1.0 |
| HB Polyol 1 [pbm] | — | 2.0 | 4.0 | 7.0 |
| Water [pbm] | 2.8 | 2.8 | 2.8 | 2.8 |
| Stabilizer [pbm] | 0.8 | 0.8 | 0.8 | 0.8 |
| Catalyst [pbm] | 0.55 | 0.55 | 0.55 | 0.55 |
| Isocyanate 2 [index] | 100 | 100 | 100 | 100 |

Properties

| | | | | |
|---|---|---|---|---|
| Foam density, core | 47.9 | 47.5 | 50.3 | 48.8 |
| [kg/m³] | | | | |
| Compressive strength, | 4.8 | 4.9 | 5.9 | 6.0 |
| 40% [kPa] | | | | |
| Rebound resilience [%] | 65 | 65 | 67 | 66 |

*pbm = parts by mass

The table shows that use of hyperbranched polyethers leads to the desired significant increase in the compressive strength with the same or even increased rebound resilience (examples 1 to 3).

### Examples 4-9 and Comparative Examples 2 and 3

Molded MT foams were produced and their mechanical properties were determined.

The compositions of the formulations and the results of the mechanical tests are shown in the following table.

The following table shows that use of hyperbranched polyethers leads to the desired significant increase in the compressive strength with likewise increased rebound resilience (examples 4, 5, 7 and 8). In addition, it can be seen that 4 parts of the hyperbranched polyether lead to a similar increase in hardness as 15 parts of a graft polyol, with the elasticity also increasing and the density decreasing (example 4, comparative example 2).

| | Comparative example | | Example | | | | | |
|---|---|---|---|---|---|---|---|---|
| | 2 | 3 | 4 | 5 | 6 | 7 | 8 | 9 |
| Formulation | | | | | | | | |
| Polyol 1 [pbm] | 82 | 97 | 93 | 74 | 73.5 | 78 | 89 | 88.5 |
| Polyol 2 [pbm] | 15 | — | — | 15 | 15 | 15 | — | — |
| Polyol 3 [pbm] | 3 | 3 | 3 | 3 | 3 | 3 | 3 | 3 |
| HB Polyol 1 [pbm] | — | — | 4 | 8 | 4 | 4 | 8 | 4 |
| Polyol 4 [pbm] | — | — | — | — | 4.5 | — | — | 4.5 |
| Water [pbm] | 3.0 | 3.0 | 3.0 | 3.0 | 3.0 | 3.0 | 3.0 | 3.0 |
| Stabilizer [pbm] | 0.5 | 0.5 | 0.5 | 0.5 | 0.5 | 0.5 | 0.5 | 0.5 |
| Catalyst [pbm] | 0.9 | 0.9 | 0.9 | 0.9 | 0.9 | 0.9 | 0.9 | 0.9 |
| Isocyanate 1 [index] | 90 | 90 | 90 | 90 | 90 | 90 | 90 | 90 |
| Properties | | | | | | | | |
| Foam density, core | 50.4 | 47.2 | 46.7 | 47.7 | 48.1 | 46.8 | 45.2 | 47.6 |
| [kg/m³] | | | | | | | | |
| Compressive strength, | 4.5 | 4.1 | 4.5 | 7.4 | 6.4 | 5.9 | 5.3 | 4.8 |
| 40% [kPa] | | | | | | | | |
| Rebound resilience [%] | 55 | 55 | 62 | 57 | 61 | 59 | 61 | 65 |

1. A flexible polyurethane foam which can be obtained by mixing
a) polyisocyanates with
b) at least one relatively high molecular weight compound having at least two reactive hydrogen atoms,
c) hyperbranched polyethers,
d) if appropriate a low molecular weight chain extender and/or crosslinker,
e) a catalyst,
f) blowing agents and
g) if appropriate other additives.

2. The flexible polyurethane foam according to claim 1, wherein the hyperbranched polyether c) are condensation products of trifunctional and higher-functional alcohols and, if appropriate, bifunctional alcohols.

3. The flexible polyurethane foam according to claim 1 or 2, wherein the component b) comprises a polymer-modified polyol.

4. The flexible polyurethane foam according to claim 3, wherein the polymer-modified polyol is a graft polyetherol or a graft polyesterol having a content of thermoplastic polymer of from 5 to 60% by weight, based on the total weight of the polymer-modified polyol.

5. The flexible polyurethane foam according to claim 3 or 4, wherein the component b) comprises more than 5% by weight, based on the total weight of the component b), of polymer-modified polyol.

6. The flexible polyurethane foam according to any of claims 1 to 5, wherein the components (a), (b), (c), if appropriate (d) and (f) are reacted in such amounts that the equivalence ratio of NCO groups to the sum of the reactive hydrogen atoms of the components (b), (c), if appropriate (d) and (f) is 0.7-1.25:1.

7. A process for producing flexible polyurethane foam, which comprises mixing and reacting
a) polyisocyanates with
b) at least one relatively high molecular weight compound having at least two reactive hydrogen atoms,
c) hyperbranched polyethers,
d) if appropriate a low molecular weight chain extender and/or crosslinker,
e) a catalyst,
f) blowing agents and
g) if appropriate other additives as defined in any of claims 1 to 6.
